(19) United States
(12) Patent Application Publication
(10) Pub. No.: US 2014/0053623 A1
(43) Pub. Date: Feb. 27, 2014

(54) HOT EXTRUSION METHOD FOR PRODUCING A METAL PART, EXTRUSION TOOL FOR IMPLEMENTATION IT AND LANDING GEAR ROD THUS PRODUCED

(71) Applicant: Laurent Hebrard, Orcines (FR)

(72) Inventor: Laurent Hebrard, Orcines (FR)

(21) Appl. No.: 13/825,119

(22) PCT Filed: May 4, 2012
(86) PCT No.: PCT/EP12/58235

§ 371 Date: Oct. 4, 2013

(30) Foreign Application Priority Data
May 10, 2011 (FR) 1154020

(51) Int. Cl. B21C 37/06; B64C 25/00

(52) U.S. Cl. CPC B21C 37/06; B64C 25/001
USPC 72/273; 428/600

(57) ABSTRACT

A hot extrusion method for producing a metal piece comprising a tubular portion whereof one of the two ends is extended by a complex shape is provided. The method comprises: heating a billet from which the piece is made; and transferring the billet into a press extrusion tool, the tool including a cavity where the billet is placed and the shape of which substantially corresponds to the outer shape of the piece. The metal has, cold, a flow stress equal to or above 200 MPa. The complex shape and tubular portion are made by the following successive steps: at least one direct extrusion step using the first punch to produce the complex shape; a step for replacing the first punch with a second punch on the tool; at least one reverse extrusion step in the same tool to produce the tubular portion; and a step for evacuating the extruded piece.

The invention relates to the metallurgy field, and more particularly hot extrusion methods for producing a metal part including a tubular portion and a complex shape, primarily for aeronautic applications, such as an aircraft landing gear rod.

Usually, the landing gear rod includes two portions: a tubular portion called the barrel, and a yoke that extends the non-emerging end of the barrel. The barrel penetrates inside the main portion of the gear, which is called the box, and forms a sliding connection therewith in particular making up a suspension-damping system. For that reason, the gear rod is also called sliding rod. The axle of the wheels (of which there are at least two) is connected to the yoke by a pivot link. The yoke has a complex shape, as it in particular includes one or more radial and/or axial protuberances (extensions).

This type of part, which requires high mechanical properties for use (specific strength, tenacity, fatigue resistance, etc.), is generally made from materials that it is difficult to transform cold by stamping, forging, rolling and/or extrusion. The materials making up these parts are, for example, titanium alloys or steels having a flow resistance (flow stress) greater than or equal to 200 MPa.

It is known to make this type of part using several successive hot transformation and machining steps, i.e. in particular:

at least one forging step to form a forged stub;

at least two stamping steps to produce the complex shape of the yoke and the outside of the barrel;

several intermediate heating steps;

then at least one non-emerging piercing of the barrel to give it its tubular shape, followed by a finishing bore, to produce the inner core of the barrel.

This series of steps is long, expensive, and requires several manipulations of the part between the different aforementioned steps, with the risk of damaging the part upon each manipulation.

Furthermore, the machining operation intended to produce the non-emerging piercing of the barrel has two major drawbacks:

it causes significant machining stresses in the part, which may be deformed or damaged; and

it also generates a significant loss of material; this material being in the form of shavings, it is difficult to develop, which is even more detrimental inasmuch as it is expensive, in particular in the case of titanium alloys.

Furthermore, due to the massiveness of the piece during the different forging and stamping steps (a common size is in the vicinity of 400 mm in diameter and 2500 mm long), it is difficult to monitor the metallurgical health of the piece before the final piercing. In fact, due to this massiveness, the non-destructive checks commonly done for this type of piece, such as ultrasound inspection, do not make it possible to effectively detect all of the flaws that the piece may contain due to the dimensions of the piece, which makes certain zones relatively inaccessible to ultrasounds.

It is known to produce, integrally by reverse extrusion (i.e. by an extrusion operation in which the non-deformed portion of the billet is immobile relative to the container containing it, or in which the deformed portion flows in a direction opposite that of the movement of the punch) of the tubular shapes having an axial extension at the non-emerging end of the tube, and therefore having a morphology comparable to that of the landing gear rods (see document GB-A-1 459 641). However, these methods are generally implemented only for materials that are easily cold-transformable (having a flow resistance when cold of less than 200 MPa) and for parts of revolution with a substantially cylindrical outer shape that do not comprise portions having a so-called “complex” shape, i.e. a portion, such as a protuberance, whereof the bulk zone extends radially substantially beyond the outer periphery of the tubular portion of the part.

This type of method is not adapted to the manufacture of pieces only transformable when hot, which, furthermore, include one or more complex shapes. In fact, for these methods, and although the shape of the piece of GB-A-1 459 641 (which is not a landing gear piece, but a hydraulic cylinder) is relatively simple, several extrusion steps are nevertheless required. Starting from this type of method, the addition of a complex shape would involve several additional extrusion steps that would be compatible with a hot transformation, since the piece to be manufactured would cool during the method, thereby preventing the performance of the last extrusion steps.

One obvious solution to this problem would then be to perform several intermediate heatings between the extrusion steps that would require it, but these reheatings complicate the method, which would lose considerable productivity and profitability.

Furthermore, in this type of known method where the extruded piece is evacuated from the die on the punch side, a piece comprising a complex shape made, for example, opposite the punch, would require non-obvious modifications to the tooling, which would still not make it possible to evacuate the piece outside the tooling.

Furthermore, the production of a complex shape by extrusion is more difficult to obtain because, in that case, the material of the piece flows much less easily to fill the corresponding cavity in the die than to form a cylindrical shape. Nothing in the state of the art makes it possible to offset this drawback.

Today, there is therefore a need to simplify and reliabilize the method for manufacturing landing gear rods, as well as pieces with similar shapes and degrees of massiveness, made from materials that are difficult to transform when cold such as steels or alloys (in particular titanium alloys) having a flow stress which, when cold, is greater than 200 MPa and are generally only transformable when hot.

The aim of the invention is therefore to propose a method for producing a metal piece comprising a tubular portion whereof one of the two ends is extended by a so-called “complex” shape in the previously explained sense, which meets this need and provides a solution to the aforementioned drawbacks.

To that end, the invention relates to a hot extrusion method for producing a metal piece comprising a tubular portion whereof one of the two ends is extended by a complex shape, said method comprising:

a prior step for heating a billet from which the piece is to be made, to decrease its strain strength; and

a hot transfer step for transferring said billet into a press extrusion tool, the tool including a die comprising a cavity in which the billet is placed and the shape of which substantially corresponds to the outer shape of the piece to be obtained after extrusion;

characterized in that said metal has, cold, a flow stress greater than or equal to 200 MPa, said complex shape is made by direct extrusion and said tubular portion is made by reverse extrusion, and in that it successively comprises:

at least one direct extrusion step using the first punch to produce the complex shape and thereby obtain a semi-finished piece;

a step for replacing the first punch with a second punch on the extrusion tool, the second punch moving in the same direction and the same sense as the first punch;

at least one reverse extrusion step in the same extrusion tool (6) to produce the whole tubular portion of the piece; and

a step for evacuating the extruded piece outside the extrusion tool.

The complex shape may be non-axisymmetric.

The end of the tubular portion extended by the complex shape may be non-emerging, and the complex shape has a bulk zone that extends radially beyond the outer periphery of the tubular portion.

The reverse extrusion step may follow the direct extrusion step without intermediate heating of the semi-finished piece.

The cavity formed in the die and which receives the billet may have a globally cylindrical and non-emerging shape with a bored portion, the punch(es) being designed to be able to move in the bored portion of the cavity.

The first punch may have an outer diameter that is adjusted to the inner diameter of the bored portion of the cavity to avoid a reverse flow of the material during the direct extrusion step.

The second punch may have a diameter smaller than that of the first punch to allow reverse extrusion of the material around the second punch.

A cylindrical sleeve may be fastened around the second punch, said cylindrical sleeve having an outer diameter that is adjusted to the inner diameter of the bored portion of the cavity, said cylindrical sleeve and the second punch defining an annular zone intended to form the tubular portion of the piece.

The die may be heated during the extrusion.

The extruded piece may be made from titanium alloy.

The extruded piece may be made from TI 10-2-3 alloy or Ti-5-5-5-3 alloy.

The piece may be a landing gear rod, and during the prior heating step of the billet, said billet is brought to a temperature between 700° C. and the beta transus temperature of the alloy, and in that said temperature is maintained for at least 2 hours.

The diameter of the tubular portion of said piece may be comprised between 350 and 500 mm, and said temperature is maintained for at least 4 hours.

During the first extrusion step, the work speed of the first punch is less than or equal to 20 mm/s, preferably less than or equal to 15 mm/s, and in that during the second step, the work speed of the second punch is less than or equal to 30 mm/s, preferably less than or equal to 20 mm/s.

The extruded piece may be made from a steel.

The extruded piece may be made from an NC40SW steel.

The piece may be a landing gear rod, in that during the prior heating step of the billet, the billet is brought to a temperature between 950° C. and 1250° C., and the heating temperature is maintained for at least 2 hours.

During the first extrusion step, the work speed of the first punch may be less than or equal to 40 mm/s, and during the second step, the work speed of the second punch is less than or equal to 60 mm/s.

The invention also relates to an extrusion tool for implementing the preceding method, characterized in that it includes a die being made up of at least two portions separated by a joint plane situated at the level of the complex shape, such that when the two portions of the die are disassembled, it is possible to evacuate the extruded piece outside the extrusion tool, and in that it comprises two punches, the first punch making it possible to produce said complex shape through a direct extrusion action on the billet, and the second punch making it possible to produce the whole of said tubular portion by a reverse extrusion operation.

It may comprise a heating device.

The heating device may be an induction heating device.

The tool may include a cylindrical sleeve fastened around the second punch, said cylindrical sleeve having an external diameter adjusted to the internal diameter of the inner bore of the die, said cylindrical sleeve and said second punch defining an annular recess intended to shape the tubular portion of the piece.

The invention also relates to a landing gear rod made from a titanium alloy or high-strength steel characterized in that it is obtained by implementing the preceding method and comprises a tubular portion forming the barrel of the landing gear rod and a complex shape forming the yoke of the rod.

It may be made from Ti-10-2-3 titanium alloy, Ti 5-5-5-3 titanium alloy, or NC40SW steel.

As will have been understood, the hot extrusion method according to the invention includes the following series of steps:

a prior heating step of the piece to decrease its strain strength;

a step for transferring the heated piece into a press extrusion tool, the tool including a die comprising a cavity in which the piece to be extruded is placed, and the shape of which corresponds to the outer shape of the piece to be obtained after extrusion;

at least one direct extrusion step using a first punch to produce only the complex shape situated at one of the ends of the piece;

a step for replacing the first punch with a second punch on the extrusion tool, the second punch being mounted in a position coaxial to that previously occupied by the first punch, such that the second punch can move in the same direction and the same sense as the first punch;

a reverse extrusion step using the second punch to produce the whole tubular portion of the piece; and

a step for evacuating the extruded piece outside the extrusion tool.

“Complex shape” refers, in the context of the present invention, to a shape of the piece where the bulk zone extends radially beyond the outer periphery of the tubular portion.

The piece may not be completely of revolution. This is in particular the case for a landing gear rod whereof the yoke of complex shape is non-axisymmetric, and comprises radial/axial protuberances.

The shaping may also comprise more than two extrusion steps, each done with a different punch.

Thus, after an initial heating, the extrusion method makes it possible, with a single die and at least two different punches, to produce, from a piece of raw material (material billet), and without having to move the piece from one tool to another between two extrusion steps, a piece having both the tubular portion and a complex shape at the non-emerging end of the tubular portion.

The method therefore makes it possible to manufacture, with a simple series of steps, pieces with complex shapes from materials that are usually difficult to transform when cold by stamping, forging, rolling and/or extrusion, such as steels or alloys, in particular titanium alloys, having, when cold, a flow stress greater than or equal to 200 MPa, in particular those intended for aeronautic applications.

The invention differs from the known processes for making parts having a tubular portion extended by a complex shape, described for example in documents FR-A-1 573 666, De-A-1929147, US-A-2006/016077 and US-A-2006/0016237 in that, simultaneously:

the extrusion is performed in two steps instead of one in the first two cited documents;

and the first extrusion step is devoted only to the forming of the complex shape, the whole tubular portion being shaped in the second step, while in the last two cited documents, the shaping of the tubular portion is initiated during the first extrusion step.

These features, advantageously, allow to treat metals which are difficult to shape, as they have, cold, a flow stress greater than or equal to 200 MPa, in order to obtain parts of big size. This would not be possible with the processes described in said documents.

The pieces manufactured using the method according to the invention can be massive, as is for example the case for landing gear rods. These may have a rod diameter larger than 400 mm and reach 2500 mm or more long.

Furthermore, the central hole of the landing gear rod is made directly during the reverse extrusion step, which avoids having to pierce the piece later by removing material, which would be restrictive for the piece and would risk damaging it.

After the manufacture of piece, said piece is subject to traditional non-destructive checks.

Advantageously, according to the invention, the reverse extrusion step immediately follows the direct extrusion step, i.e. without intermediate reheating of the piece. This is made possible by the fact that the piece is not moved from one tool to another between the different extrusion steps. It can therefore be kept hot enough throughout the entire method to allow it to deform easily during the extrusion steps.

The material to be extruded flows more difficultly to form the complex shape than to form the tubular shape by reverse extrusion. That is why, in the first alternative of the invention, the complex shape is made by direct extrusion, before making the tubular portion by reverse extrusion.

If the punch must pierce the piece, there is a risk of deformation of the end of the piece or tearing of the material. That is why the end of the tubular portion, which is extended by the complex shape, is preferably non-emerging. For landing gear rod applications for aircrafts, it is also preferred to have a non-emerging barrel to more easily preserve the hydraulic sealing. If necessary, this end may be pierced later by simple machining.

The cavity formed the die and which receives the piece to be extruded has a generally cylindrical and non-emerging shape, with a bored portion. The first and second punches are mounted to be able to slide in the bore of the cavity.

The second punch has a smaller diameter than that of the first punch to allow reverse extrusion of the material around the second punch.

The first punch has an outer diameter, which, to within the functional play, is adjusted to the bore of the cavity of the die to avoid a reverse flow of the material during the direct extrusion step. One thus benefits from the full power of the press to produce the complex shape.

In a first alternative of the invention, the extruded piece is made from a titanium alloy, and preferably Ti 10-2-3 (Ti, 10% V, 2% Fe, 3% Al) or Ti 5-5-5-3 (Ti, 5% Al, 5% V, 5% Mo, 3% Cr).

During the prior heating step, the temperature of the piece made from titanium alloy is brought to a temperature between 700° C. and the beta transus temperature of the titanium alloy (approximately 800° C. for a Ti 10-2-3 and approximately 850° C. for a Ti 5-5-5-3). As a function of the massiveness of the piece, the heating temperature is maintained for at least 2 hours, for example, between 4 and 6 hours for a piece with a diameter between 400 and 500 mm, so as to be certain to obtain a homogenous temperature in the entire piece.

In a second embodiment, the extruded piece is made from high strength steel and preferably NC40SW steel (40NiSiCrMo7). The NC40SW steel has a nominal composition which, traditionally, in weighted percentage, is substantially as follows:

carbon: 0.4%;

nickel: 1.8%;

silicon: 1.6%;

chromium: 0.85%;

molybdenum: 0.4%;

the rest being iron and impurities resulting from the development.

During the prior heating step, the steel piece is brought to a temperature between 900° C. in 1250° C. to lower the flow stresses of the material and allow transformation of the material by hot extrusion. Preferably, the heating temperature is determined so that the flow stresses of the material, during the extrusion, are less than 200 MPa and preferably less than 150 MPa. As a function of the massiveness of piece, the heating temperature is maintained for at least 2 hours, for example between 4 and 6 hours for a piece with a diameter between 350 and 500 mm, here again with the aim of guaranteeing that the temperature is homogenous in the entire piece.

The invention is also based on a tool for implementing the aforementioned method. The die comprises at least two elements, separated by a joint plane that is located at the portion of the tool imposing the complex shape, such that, when the two elements are disassembled, it is possible to evacuate the extruded piece outside the extrusion tool. Contrary to the prior art, the evacuation of the extruded piece outside the die is not need to be done on the punch side, which would be impossible with a piece having a complex shape.

Owing to the method and the device according to the invention, it is possible in particular to produce the landing gear train from a titanium alloy or a high-strength steel suitably chosen, including a tubular portion that makes up the barrel of the rod and a complex shape that makes up the yoke of the rod.

For a landing gear rod made from titanium alloy, for example Ti 10-2-3, the nominal work speed of the first punch in direct extrusion is less than or equal to 20 mm/s, preferably less than or equal to 15 mm/s, and that of the second punch in reverse extrusion is less than or equal to 30 mm/s, preferably less than or equal to 20 mm/s.

For a landing gear rod made from high-strength steel, for example NC40SW, the nominal work speed of the first punch is preferably less than or equal to 40 mm/s and that of the second punch is preferably less than or equal to 60 mm/s.

In general, it is possible to work with a speed of the second punch 5 that is higher than that of the first punch, as the tubular shape to be imposed for the second punch is easier to obtain than the complex shape obtained using the first punch.

The working speed of the punches is preferably reduced at the end of travel of the punch, which corresponds to the end of filling of the material in the cavity of the die. In this way, better filling of the cavity is ensured.

The invention will be better understood upon reading the following description, provided in reference to the following appended figures:

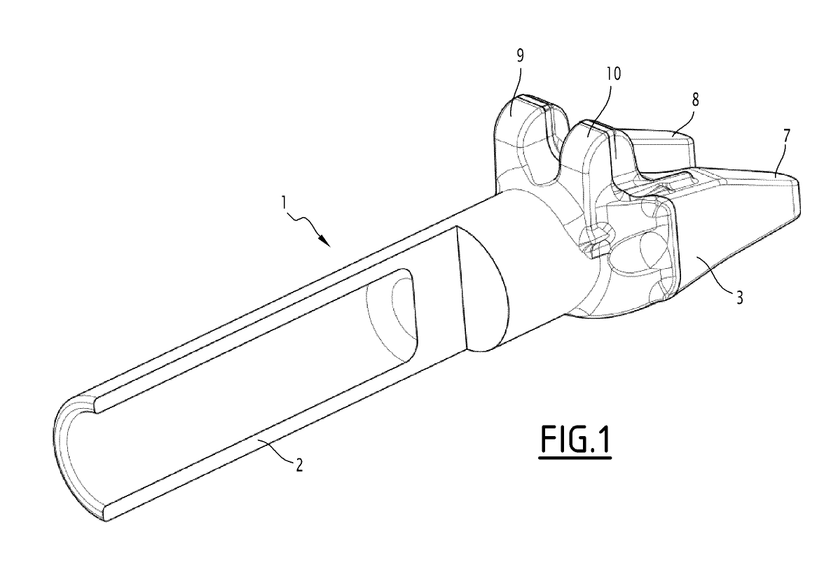

FIG. 1, which shows one example of a landing gear rod that may be produced according to the invention;

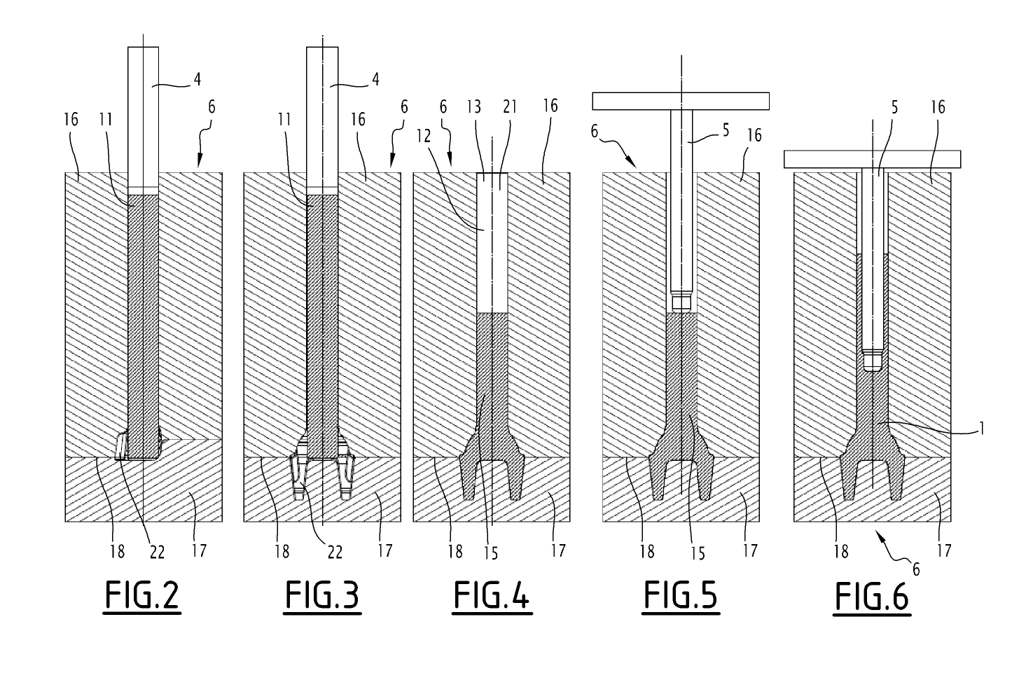

FIGS. 2 to 6, which show the series of steps of a first alternative of the method according to the invention resulting in the manufacture of the piece of FIG. 1;

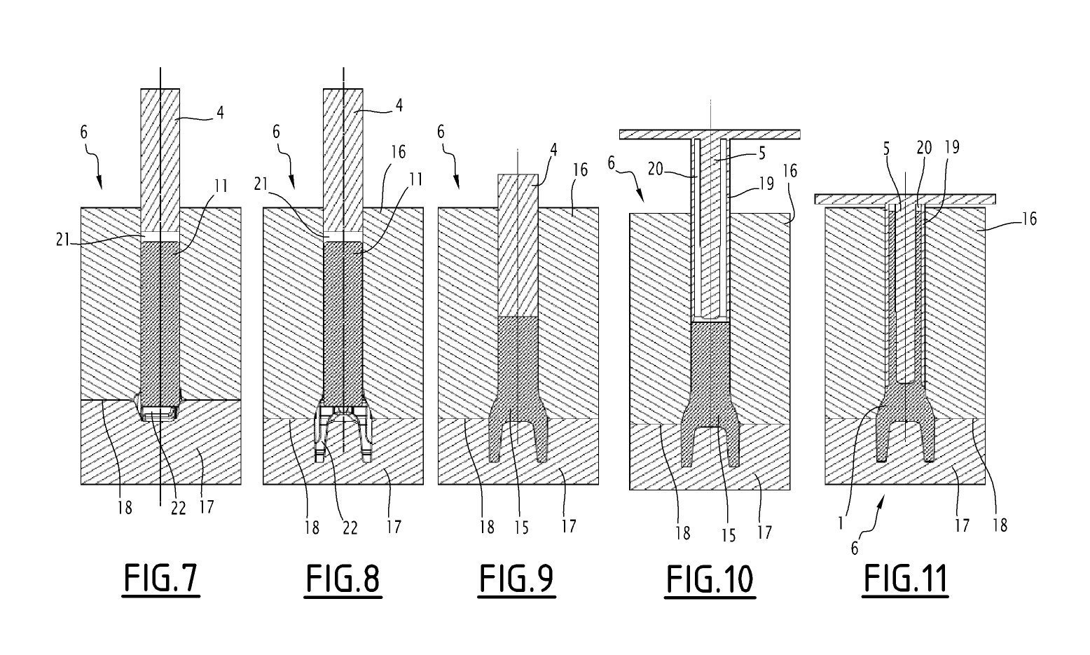

FIGS. 7 to 11, which show the series of steps of a second alternative of the method according to the invention resulting in the manufacture of the piece of FIG. 1.

FIG. 1 illustrates a landing gear rod 1 in perspective and partial cross-sectional view as obtained after implementing the method according to the invention. The rod 1 comprises a tubular portion 2 shown in partial cross-section, making up the barrel, and a complex portion 3 making up the yoke. In this example, the tubular portion is non-emerging.

FIGS. 2 to 6 are cross-sectional views showing an extrusion tool and the different steps of a first alternative of the method according to the invention for manufacturing the landing gear rod 1 illustrated in FIG. 1.

It must be understood to FIGS. 2 to 6 are diagrammatic. For example, the guiding and centering means of the punches 4, 5 relative to the die 6 are not shown. They follow completely traditional designs on tools of this type.

The landing gear rod 1 shown in FIG. 1, which is for example made from titanium alloy TI 10-2-3, as obtained after implementing the method according to the invention. This geometry, although very close to the finished piece, is not definitive, as the piece must traditionally, before being assembled with the other pieces making up the landing gear, undergo machining to eliminate over thicknesses and to obtain functional surfaces as well as heat treatments in order in particular to achieve the required mechanical usage properties. However, no heavy shaping operations are necessary thereafter. This piece has a total length of approximately 2500 mm, and for example includes two portions:

a non-emerging tubular portion 2 that forms the barrel of the rod 1, and the outer diameter of which is for example approximately 386 mm; and

a complex shape 3 that extends the non-emerging end of the tubular portion 2 and forms the yoke of the landing gear.

The shape of the yoke is said to be “complex” in that it includes protuberances or protrusions 7, 8, 9, 10 that extend radially and axially beyond the enclosure of the tubular portion 2. Thus, the yoke 3 has a bulk zone that extends radially beyond the outer periphery of the tubular portion 2.

This complex shape of the yoke 3 associated with the tubular portion 2 makes it difficult to manufacture the landing gear rod 1 using the traditional methods and devices.

Owing to the method according to the invention, described below in the example embodiments, in particular those illustrated by FIGS. 2 to 6 on the one hand and 7 to 11 on the other, the manufacture of such a piece 1 is considerably simplified relative to the state of the art described in the preamble. In fact, between the initial raw shape (the material billet 11 shown in FIGS. 2 and 3, which may have been previously machined to allow it to be inserted into the die) and the geometry of the landing gear rod 1 shown in FIG. 1, the number of manufacturing steps has been reduced, the piece is not moved from one tool to another and, after initial heating so that the piece can be heat-deformed, no intermediate heating of the piece is necessary during the shaping thereof.

FIGS. 2 to 6 show an extrusion tool as well as four successive steps of the method. FIGS. 2 and 3 correspond to the same extrusion step with two different views shifted by 90°. FIGS. 4 to 6 show the tool seen from the same angle as in FIG. 3. The extrusion tool is placed under a single-directional press with a single die block, exerting its action on the successive punches 4, 5, and the power of which is for example approximately 15 kt.

The tool comprises a die 6 and a set of two different punches 4, 5. The die 6, the specific composition of which in multiple parts will be described later, is provided with a globally cylindrical cavity 12, oriented vertically, and open at the upper end 13 thereof to receive a billet 11 of material to be extruded. The shape of the cavity 12 combined with that of the second punch 5 corresponds to the shape of the landing gear rod 1 to be obtained after the last extrusion step of the method according to the invention.

The upper portion 21 of the cavity 12 is bored and corresponds to the outer diameter of the barrel 2, except when the second punch 5 is provided with an outer cylindrical sleeve as will be considered in the second alternative embodiment of the invention (not shown). The bored cylindrical portion 21 of the cavity 12 makes it possible to guide the first punch 4, and potentially the second punch 5 when it is provided with an outer cylindrical sleeve, more effectively.

The lower portion 22 of the cavity 12 corresponds to the complex outer shape of the yoke 3 of the landing gear rod 1.

FIGS. 2 and 3 show, along two viewing angles shifted by 90°, a material billet 11 placed in the vertical position in the extrusion tool, more specifically in the cavity 12 of the die 6 of the extrusion tool.

In the illustrated example, the billet 11 made from Ti 10-2-3 has a cylindrical shape of revolution, a diameter of approximately 380 mm, and a length of approximately 2000 mm. The material billet 11 typically comes from a forged slug, or a slug that is forged, then rolled when the slug must have a relatively small diameter, for example smaller than 100 mm. It may, to that end, be necessary, after forging, to proceed with several rolling steps, including a blooming step after the forging.

Before it is introduced into the die 6, the billet 11 has previously been heated in a treatment furnace at a temperature of 730° C. This temperature has been maintained for approximately 6 hours, so as to obtain the same temperature between the skin and the core of the billet 11. The purpose of this heat treatment is to allow hot deformation of the material of the billet 11 during the extrusion steps (“hot extrusion steps”). The cold deformation of the piece made from Ti 10-2-3 would be difficult, or would prematurely damage the extrusion tool.

In FIGS. 2 and 3, the first extrusion punch 4 is pre-engaged in the cavity 12 of the die 6. The upper portion 21 of the cavity 12 has a cylindrical shape of revolution that corresponds to the outer diameter of the barrel 2 of the landing gear rod 1 after extrusion. The lower portion 22 of the cavity 12 has a complex shape including protuberances, i.e. axial and radial protrusions. The complex shape is the negative of that of the yoke 3 of the landing gear rod. The upper portion 21 of the cavity 12 is bored so that the outer diameter of the first punch 4 adjusts, to within the functional play, to that bore 21.

FIG. 4 shows the end of the direct extrusion step of the billet 11 by moving and sliding the first punch 4 in the bore 21 of the cavity 12. This direct extrusion step makes it possible to obtain, at the end of the billet 11, a complex shape that corresponds to that of the yoke 3 of the landing gear rod 1.

Making the complex shape of the yoke 3 by direct extrusion requires a less powerful process for controlling the first punch 4 than if that same shape was made by reverse extrusion, since the material flows in the direction of movement of the first punch 4 without having to rise back up along it.

Furthermore, making the complex shape of the yoke 3 of the landing gear rod 1 by direct extrusion for producing the tubular portion 2 of that same rod 1 by reverse extrusion allows the first punch 4 to exert a force that is distributed over the entire upper surface of the billet 11, and not only over an annular end that would correspond to the open end of the tubular portion 2 of the landing gear rod 1.

For an identical press force, an annular end would take on, at the upper surface thereof, a greater pressure than the end of a billet of solid material.

As a result, exerting, according to the invention, an extrusion force directly on the billet 11 makes it possible to transmit a more intense force than if it were transmitted to a tubular portion, which, furthermore, would be more fragile.

To maximize, at equal press power, or even lower press power, the extrusion forces during the production of the complex shape of the yoke 3, it is therefore preferable to produce the complex shape by direct extrusion before the tubular portion 2 is itself formed by reverse extrusion, and this is one of the principles on which the invention is preferably based.

During the direct extrusion of the piece making it possible to produce the complex shape of the yoke 3, the travel speed of the punch may be, at the beginning of extrusion, approximately 15 mm/s. As stated, at the end of extrusion, this speed may be gradually reduced to ensure better filling of the complex shape 22 of the die 12.

In FIG. 4, the direct extrusion step is, at that stage, completed, and a semi-finished piece 15 has been obtained. The complex shape of the yoke 3 is produced, and the first punch 4 has been removed. In FIG. 5, the punch 4 has been replaced by the second punch 5. One can see that the second punch 5, with a smaller diameter than the first 4, is already pre-engaged in the upper portion 21 of the cavity 12 of the die 6. Means for centering the punch 5 (not shown) ensure that the longitudinal axis thereof is indeed combined with the longitudinal axis of the cavity 12, as was the longitudinal axis of the first punch 4.

Between the steps shown in FIGS. 4 and 5, the semi-finished piece 15 made from the billet 11 has not been moved; only the two punches 4, 5 have been exchanged.

FIG. 6 corresponds to the reverse extrusion step ensuring shaping of the tubular portion 2 of the landing gear rod 1. Owing to the force exerted by the second punch 5 on the semi-finished piece 15, the material rises back up along and around the second punch 5 to form the tubular portion 2 (the barrel) of the landing gear rod 1. One thus obtains the final piece 1, for which only the final finishing machining is necessary to eliminate overthicknesses and obtain functional surfaces, as well as the typical heat treatments in particular to achieve the required mechanical properties.

During the reverse extrusion to form the tubular portion 2, the speed of travel of the second punch 5 is, at the beginning of extrusion, approximately 20 mm/s. Preferably, it may be gradually reduced at the end of extrusion.

During this reverse extrusion step, the semi-finished piece 15 is still worked hot. It has been possible to maintain the temperature of the piece 15 for several reasons.

The first reason is that the semi-finished piece 15 did not need to be moved from one tool to another, since the same die 6 is used for both extrusion steps. In this way, the different steps may be linked quickly without the semi-finished piece 15 having time to cool.

A second reason is that upon each extrusion step, the punch 4 or 5 transmits energy to the billet 11 or to the semi-finished piece 15, energy that is converted into heat and contributes to maintaining the temperatures of the metal to be worked and the die 6. Another reason comes from the massiveness of the die 6 of the tool in which the billet 11 to be extruded, then the semi-finished piece 15 completely penetrate. In fact, such massiveness of the tool provides significant thermal inertia, which slows the cooling of the worked metal.

In one advantageous alternative embodiment of the tool, the tool can also be heated and maintained at temperature before, or also during, the extrusion, for example using an induction heating system.

In a last step that is not shown, the final piece 1 is evacuated from the tool. To that end, the die 6 of the tool is assembled in two portions 16, 17. The joint plane 18 of the two portions 16, 17 is substantially perpendicular to the longitudinal axis of the die 6 and situated at the two radial extensions 9, 10 (radial protuberances) to be able to free the final piece 1 after having gone back up the second punch 5 and disassembled the two portions 16, 17 of the die 6. As shown in FIG. 2, the joint plane 18, in the illustrated example, is not regular and passes through the points of the periphery of the complex shape 3 that are furthest from the longitudinal axis of the tube 2, so as to be able to easily remove the final piece 1 from the tool.

It will easily be understood that depending on the complexity of the final piece 1 to be produced and the massiveness of the tool, the number of portions assembled to form the die 6 may be greater than two.

In a second alternative embodiment, illustrated in FIGS. 7 to 11, the second punch 5 is provided with an outer cylindrical sleeve 19 concentric to the punch 5. The cylindrical sleeve 19 is fastened around the second punch 5, and therefore forms, with the central portion thereof, an annular recess 20 in which the semi-finished piece 15 flows during reverse extrusion to form the tubular portion 2 of the landing gear rod 1. By modifying the inner diameter of the sleeve 19 and the diameter of the central portion of the second punch 5, it is possible to form different diameters for the tube 2, and thus to manufacture different landing gear rods 1 all only modifying the second punch 5. Furthermore, another advantage of the cylindrical sleeve 19 is being able to more effectively guide the second punch 5 when it moves inside the die 6, since the outer diameter of the sleeve is, as for the first punch 4, adjusted to the inner bore 12 of the die 6.

In the example shown in FIGS. 7 to 11, the rod 1 has a different shape from that of the examples of FIGS. 1 to 6, which explains why, in FIGS. 7 to 11, the joint plane 18 is regular.

Advantageously, to prevent the semi-finished piece 15 from cooling between the different extrusion operations, the die 6 of the tool is heated before placing the billet 11 therein, and/or can be kept hot during the shaping, for example by an induction heating system, outside the tool or integrated into the tool.

1. A hot extrusion method for producing a metal piece comprising a tubular portion whereof one of the two ends is extended by a complex shape, said method comprising:
heating a billet from which the metal piece is to be made, to decrease its strain strength; and
transferring said billet into a press extrusion tool, the tool comprising a die comprising a cavity in which the billet is placed and a shape of which substantially corresponds to an outer shape of the metal piece to be obtained after extrusion;
wherein said metal has, when cold, a flow stress greater than or equal to 200 MPa, said complex shape is made by direct extrusion and said tubular portion is made by reverse extrusion via a process comprising the following successive steps:
at least one direct extrusion step using a first punch to produce the complex shape and thereby obtain a semi-finished piece;
a step for replacing the first punch with a second punch on the press extrusion tool, the second punch moving in a same direction and a same sense as the first punch;
at least one reverse extrusion step in the same extrusion tool to produce a whole tubular portion of the metal piece; and
a step for evacuating the extruded metal piece outside the extrusion tool.

2. The method according to claim 1, wherein the complex shape is non-axisymmetric.

3. The method according to claim 1, wherein the end of the tubular portion extended by the complex shape is non-emerging, and the complex shape comprises a bulk zone that extends radially beyond the outer periphery of the tubular portion.

4. The method according to claim 1, wherein the reverse extrusion step follows the direct extrusion step without intermediate heating of the semi-finished piece.

5. The method according to claim 1, wherein the cavity formed in the die and which receives the billet comprises a globally cylindrical and non-emerging shape with a bored portion, the first and/or second punch(es) being designed to be able to move in the bored portion of the cavity.

6. The method according to claim 5, wherein the first punch has an outer diameter that is adjusted to an inner diameter of the bored portion of the cavity to avoid a reverse flow of a material of the billet during the direct extrusion step.

7. The method according to claim 6, wherein the second punch has a diameter smaller than that of the first punch to allow reverse extrusion of the material around the second punch.

8. The method according to claim 6, wherein a cylindrical sleeve is fastened around the second punch, said cylindrical sleeve having an outer diameter that is adjusted to the inner diameter of the bored portion of the cavity, said cylindrical sleeve and the second punch defining an annular zone intended configured to form the tubular portion of the metal piece.

9. The method according to claim 1, wherein the die is heated during the extrusion.

10. The method according to claim 1, wherein the extruded piece comprises titanium alloy.

11. The method according to claim 10, wherein the extruded piece comprises TI 10-2-3 alloy or Ti-5-5-5-3 alloy.

12. The method according to claim 10, wherein the metal piece is a landing gear rod, and in that during said heating the billet, said billet is brought to a temperature between 700° C. and the beta transus temperature of the alloy, and in that said temperature is maintained for at least 2 hours.

13. The method according to claim 12, wherein a diameter of the tubular portion of said metal piece comprises between 350 and 500 mm, and in that said temperature is maintained for at least 4 hours.

14. The method according to claim 12, wherein during the direct extrusion step, a work speed of the first punch is less than or equal to 20 mm/s, preferably less than or equal to 15 mm/s, and in that during the reverse extrusion step, a work speed of the second punch is less than or equal to 30 mm/s, preferably less than or equal to 20 mm/s.

15. The method according to claim 1, wherein the extruded metal piece comprises a steel.

16. The method according to claim 15, wherein the extruded metal piece comprises an NC40SW steel.

17. The method according to claim 15, wherein the metal piece is a landing gear rod, in that during said heating the billet, the billet is brought to a temperature between 950° C. and 1250° C., and in that the heating temperature is maintained for at least 2 hours.

18. The method according to claim 17, wherein during the direct extrusion step, a work speed of the first punch is less than or equal to 40 mm/s, and during the reverse extrusion step, a work speed of the second punch is less than or equal to 60 mm/s.

19. An extrusion tool useful in producing a metal piece comprising a tubular portion whereof one of the two ends is extended by a complex shape, wherein it includes the tool comprises:
a die comprising at least two portions separated by a joint plane situated at a level of the complex shape, such that when the two portions of the die are disassembled, it is possible to evacuate the extruded metal piece outside the extrusion tool, and
two punches, the first punch configured to produce said complex shape through a direct extrusion action on the a billet, and the second punch configured to produce a whole of said tubular portion by a reverse extrusion operation.

20. The extrusion tool according to claim 19, wherein it comprises a heating device.

21. The extrusion tool according to claim 20, wherein the heating device is an induction heating device.

22. An extrusion tool according to claim 19, wherein it includes a cylindrical sleeve fastened around the second punch, said cylindrical sleeve having an external diameter adjusted to an internal diameter of an inner bore of the die, said cylindrical sleeve and said second punch defining an annular recess configured to shape the tubular portion of the metal piece.

23. A landing gear rod comprising a titanium alloy or high-strength steel wherein it is obtained by the method according to claim 1 and comprises a tubular portion forming the a barrel of the landing gear rod and a complex shape forming a yoke of the rod.

24. The landing gear rod according to claim 23, wherein the rod comprises Ti-10-2-3 titanium alloy, Ti 5-5-5-3 titanium alloy, or NC40SW steel.
